(19) United States
(12) Patent Application Publication
(10) Pub. No.: US 2026/0067004 A1
(43) Pub. Date: Mar. 5, 2026

(54) TEST PLATFORM, GROUP TESTING SYSTEM, AND GROUP TESTING METHOD

(71) Applicant: Ohmplus Technology Inc., New Taipei (TW)

(72) Inventors: CHIH-YUAN CHU, New Taipei (TW); Chih-Wei Chiu, New Taipei (TW); Tsung-Ming Chen, New Taipei (TW)

(21) Appl. No.: 19/317,797

(22) Filed: Sep. 3, 2025

Related U.S. Application Data
(60) Provisional application No. 63/689,950, filed on Sep. 3, 2024.

(51) Int. Cl. H04B 17/00; H04B 17/24

(52) U.S. Cl. CPC H04B 17/0085; H04B 17/24

(57) ABSTRACT

A test platform, group testing system, and group testing method for testing multiple devices under testing are provided. The test platform includes signal transmission paths with distribution elements that distribute a measurement signal from a single port of a measurement device to multiple devices under testing. Signal receiving paths include combining elements and phase shifters that combine response signals from the devices under testing. For devices receiving signals from a common distribution element, at least one phase shifter imparts a phase shift to establish a predetermined phase difference between response signals before combining. A controller switches the test platform between first and second measurement stages by controlling phase values. The measurement device determines scattering parameters of the devices under testing based on signals received during both measurement stages, which enables efficient simultaneous testing of multiple devices while maintaining measurement accuracy.

### CROSS-REFERENCE TO RELATED APPLICATION(S)

The present disclosure claims the benefit of and priority to U.S. Provisional Patent Application Ser. No. 63/689,950, filed on Sep. 3, 2024, entitled “THE MEASUREMENT OF SCATTERING COEFFICIENTS OF RADIO FREQUENCY (RF) UNITS USING A GROUP TESTING SYSTEM AND ITS METHOD,” the content of which is hereby incorporated herein fully by reference into the present application for all purposes.

### FIELD

The present disclosure relate to test platforms, group testing systems, and group testing methods for measuring electrical characteristics, such as scattering parameters (S-parameters), of multiple devices under testing.

### BACKGROUND

In radio frequency (RF) device testing, scattering parameters (S-parameters) serve as important indicators for evaluating device characteristics. Current testing methods primarily rely on vector network analyzers to measure each device under testing sequentially. As product volumes and testing requirements increase, these traditional processes gradually reveal limitations in efficiency and operational resource allocation. While the industry has introduced various test automation and hardware integration solutions, challenges remain in system cost, operational complexity, and maintenance flexibility from both technical and economic perspectives.

Therefore, improving test efficiency and simplifying test architecture, while maintaining measurement accuracy and practical applicability remains an ongoing engineering challenge that continues to draw attention.

### SUMMARY

The present disclosure provides a test platform, a group testing system, and a group testing method suitable for measuring scattering parameters of multiple devices under testing. The disclosed approach distributes input measurement signals to multiple devices under testing and collects their response signals through multiple signal receiving paths, achieving an efficient and scalable measurement process. Phase shifters in certain signal receiving paths introduce predetermined phase differences before signal combining, ensuring signal orthogonality to facilitate subsequent signal separation and parameter calculation. This architecture simplifies test configuration, reduces measurement time, maintains parameter calculation accuracy, and accommodates different configurations and numbers of devices under testing.

According to the first aspect of the present disclosure, a test platform, adapted to connect to a measurement device and multiple devices under testing, is provided. The test platform includes multiple signal transmission paths including multiple distribution elements configured to distribute a measurement signal from a single port of the measurement device to the multiple devices under testing, and multiple signal receiving paths including multiple combining elements and multiple phase shifters. Each combining element of the multiple combining elements is configured to combine response signals from at least two of the multiple devices under testing and output a combined signal to the measurement device. For a first device under testing and a second device under testing, included in the multiple devices under testing, that receive distributed signals from a common distribution element of the multiple distribution elements and respectively generate a first response signal and a second response signal in response to the distributed signals, at least one phase shifter of the multiple phase shifters imparts a phase shift to at least one of the first response signal and the second response signal before the first response signal and the second response signal are combined by one of the multiple combining elements, such that a predetermined phase difference exists between the first response signal and the second response signal.

In some implementations of the first aspect of the present disclosure, the predetermined phase difference is 90 degrees.

In some implementations of the first aspect of the present disclosure, each phase shifter of the multiple phase shifters is switchable between a first phase value and a second phase value.

In some implementations of the first aspect of the present disclosure, the first phase value and the second phase value differ by 90 degrees.

In some implementations of the first aspect of the present disclosure, the response signals include reflected signals and transmitted signals, and the multiple signal receiving paths are configured to route the reflected signals and the transmitted signals to different ports of the measurement device.

In some implementations of the first aspect of the present disclosure, the test platform further includes multiple low noise amplifiers positioned along one or more of the multiple signal transmission paths and one or more of the multiple signal receiving paths.

In some implementations of the first aspect of the present disclosure, the multiple distribution elements include power dividers.

In some implementations of the first aspect of the present disclosure, the multiple combining elements include power combiners.

According to the second aspect of the present disclosure, a group testing system includes a measurement device, a test platform electrically connected to the measurement device and configured for connection to multiple devices under testing, and a controller coupled to the measurement device and the test platform. The test platform includes multiple signal transmission paths including multiple distribution elements configured to distribute a measurement signal from a single port of the measurement device to the multiple devices under testing, and multiple signal receiving paths including multiple combining elements and multiple phase shifters. Each combining element of the multiple combining elements is configured to combine response signals from at least two of the multiple devices under testing and output a combined signal to the measurement device. For a first device under testing and a second device under testing, included in the multiple devices under testing, that receive distributed signals from a common distribution element of the multiple distribution elements and respectively generate a first response signal and a second response signal in response to the distributed signals, at least one phase shifter of the multiple phase shifters imparts a phase shift to at least one of the first response signal and the second response signal before the first response signal and the second response signal are combined by one of the multiple combining elements, such that a predetermined phase difference exists between the first response signal and the second response signal. The controller is configured to switch the test platform between a first measurement stage and a second measurement stage by controlling phase values of the multiple phase shifters. The measurement device is configured to determine scattering parameters of the multiple devices under testing based on signals received during the first and second measurement stages.

In some implementations of the second aspect of the present disclosure, the predetermined phase difference is 90 degrees.

In some implementations of the second aspect of the present disclosure, each phase shifter of the multiple phase shifters is switchable between a first phase value and a second phase value, during the first measurement stage, the controller sets a first group of the multiple phase shifters to the first phase value and a second group of the multiple phase shifters to the second phase value, and during the second measurement stage, the controller sets the first group of the multiple phase shifters to the second phase value and the second group of the multiple phase shifters to the first phase value.

In some implementations of the second aspect of the present disclosure, the first phase value and the second phase value differ by 90 degrees.

In some implementations of the second aspect of the present disclosure, the response signals include reflected signals and transmitted signals, and the multiple signal receiving paths are configured to route the reflected signals and the transmitted signals to different ports of the measurement device.

In some implementations of the second aspect of the present disclosure, the system further includes multiple low noise amplifiers positioned along one or more of the multiple signal transmission paths and one or more of the multiple signal receiving paths.

In some implementations of the second aspect of the present disclosure, the multiple distribution elements include power dividers.

In some implementations of the second aspect of the present disclosure, the multiple combining elements include power combiners.

According to the third aspect of the present disclosure, a group testing method uses a measurement device and a test platform. The method includes: transmitting a measurement signal from a single port of a measurement device through a test platform; distributing the measurement signal through multiple signal transmission paths to multiple devices under testing connected to the test platform, the multiple signal transmission paths including multiple distribution elements; receiving response signals, generated by the multiple devices under testing in response to the measurement signal, through multiple signal receiving paths and transmitting the response signals to the measurement device, the multiple signal receiving paths including multiple combining elements and multiple phase shifters, and for a first device under testing and a second device under testing, included in the multiple devices under testing, that receive distributed signals from a common distribution element of the multiple distribution elements and respectively generate a first response signal and a second response signal in response to the distributed signals, at least one phase shifter of the multiple phase shifters imparts a phase shift to at least one of the first response signal and the second response signal before the first response signal and the second response signal are combined by one of the multiple combining elements, such that a predetermined phase difference exists between the first response signal and the second response signal; controlling the test platform to switch between a first measurement stage and a second measurement stage; and determining scattering parameters of the multiple devices under testing based on the response signals received by the measurement device during the first measurement stage and the second measurement stage.

In some implementations of the third aspect of the present disclosure, the predetermined phase difference is 90 degrees.

In some implementations of the third aspect of the present disclosure, switching between the first measurement stage and the second measurement stage includes: during the first measurement stage, setting a first group of the multiple phase shifters to a first phase value and a second group of the multiple phase shifters to a second phase value, and during the second measurement stage, setting the first group of the multiple phase shifters to the second phase value and the second group of the multiple phase shifters to the first phase value.

In some implementations of the third aspect of the present disclosure, the first phase value and the second phase value differ by 90 degrees.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a block diagram of a hardware architecture of a group testing system according to an embodiment of the present disclosure.

FIG. 2 is a flowchart of a group testing process according to an embodiment of the present disclosure.

FIG. 3 is a schematic diagram of a mixed signal path calibration procedure according to an embodiment of the present disclosure.

FIG. 4 is a flowchart of a calibration process according to an embodiment of the present disclosure.

FIG. 5 shows signal transmission paths from a port of a measurement device to each device under testing according to an embodiment of the present disclosure.

FIG. 6 shows signal receiving paths from each device under testing to a measurement device according to an embodiment of the present disclosure.

FIG. 7 is a schematic diagram illustrating calculations of scattering parameters of devices under testing by a measurement device, based on measurement results from the first measurement stage and second measurement stage, according to an embodiment of the present disclosure.

FIG. 8 is a flowchart of a group testing method according to an embodiment of the present disclosure.

### DESCRIPTION

The following description includes specific information regarding exemplary implementations of the present disclosure. The drawings and accompanying detailed descriptions in the present disclosure are directed to these exemplary implementations. However, the present disclosure is not limited to these exemplary implementations. Those skilled in the art will recognize other variations and implementations of the present disclosure. Furthermore, the drawings and illustrations in the present disclosure are generally not drawn to scale and may not correspond to actual relative dimensions.

The term “coupled” may be defined as connected, whether directly or indirectly through intermediate components, and is not necessarily limited to physical connections. When the terms “include” or “comprise” are used, they may mean “including but not limited to,” explicitly indicating an open-ended relationship of combinations, groups, series, and equivalents.

The expression “at least one of A, B and C,” “at least one of A, B or C,” or “at least one of the following: A, B and C” means “only A, or only B, or only C, or any combination of A, B and C.” The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

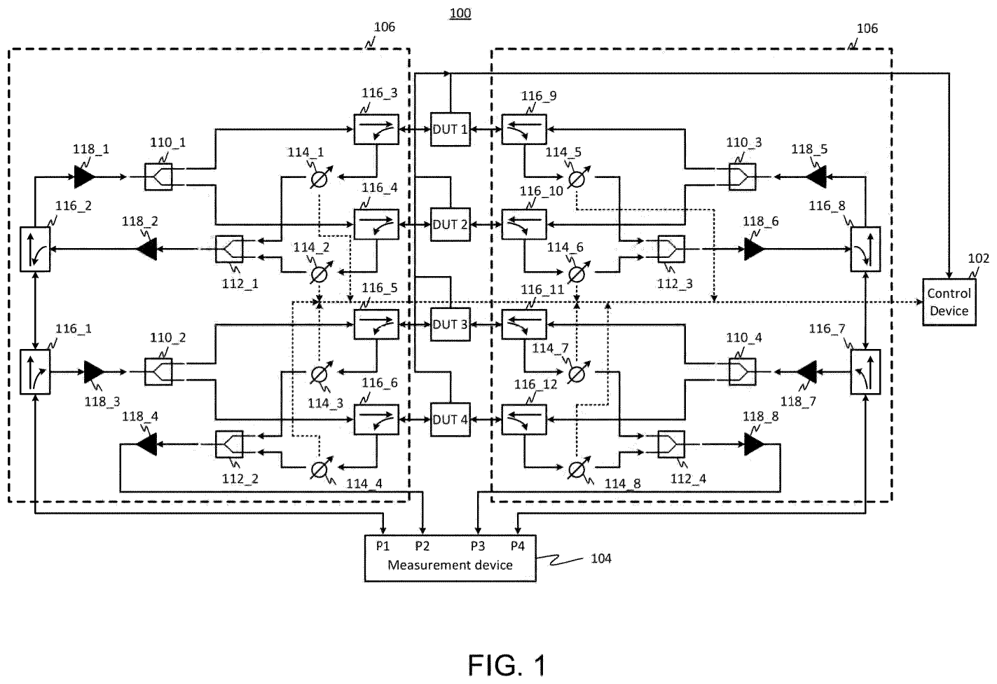

FIG. 1 is a block diagram of the hardware architecture of a group testing system 100 according to an embodiment of the present disclosure. The group testing system 100 is configured to simultaneously measure electrical characteristics, particularly scattering parameters, of multiple devices under testing (DUT), such as DUT 1 through DUT 4. The group testing system 100 includes a controller 102, a measurement device 104, and a test platform 106. The controller 102 is coupled to the measurement device 104 and the test platform 106, and the controller 102 is configured to control the test platform 106 to switch between a first measurement stage and a second measurement stage.

The controller 102 may be implemented as various forms of computing devices or controllers. The measurement device 104 may be, for example, a Vector Network Analyzer (VNA), which is configured to generate measurement signals for measuring the devices under testing and calculate scattering parameters of the devices under testing based on response signals received from the signal receiving paths during the first measurement stage and the second measurement stage. In some embodiments, the measurement device 104 may also be a modular instrument system equipped with appropriate measurement modules. The measurement device 104 typically includes a signal generator, receiver, mixer, and digital signal processing unit, capable of generating measurement signals in specific frequency ranges and analyzing received response signals. In some embodiments, the controller 102 may be integrated with the measurement device 104 as a single device, with control functions executed by a processor built into the measurement device 104.

The test platform 106 includes multiple signal transmission paths and multiple signal receiving paths. The signal transmission paths include multiple distribution elements. In this embodiment, the distribution elements are implemented as power dividers 110_1 through 110_4; however, the present disclosure is not limited thereto, and the distribution elements may also be implemented using other suitable types of coupler elements.

The distribution elements are configured to distribute a measurement signal from a single port of the measurement device 104 to the multiple devices under testing. As shown in FIG. 1, to simultaneously transmit the measurement signal from port P1 of the measurement device 104 to DUT 1 through DUT 4, power divider 110_1 is positioned on the signal transmission path between port P1 and DUT 1, DUT 2 to distribute the measurement signal from port P1 to DUT 1 and DUT 2. Power divider 1102 is positioned on the signal transmission path between port P1 and DUT 3, DUT 4 to distribute the measurement signal from port P1 to DUT 3 and DUT 4. Through this configuration, the measurement signal from a single port (e.g., port P1) of the measurement device 104 may be simultaneously transmitted to multiple devices under testing via power dividers 110_1 and 110_2.

Similarly, to simultaneously transmit the measurement signal from port P4 of the measurement device 104 to DUT 1 through DUT 4, power divider 1103 is positioned on the signal transmission path between port P4 and DUT 1, DUT 2 to distribute the measurement signal from port P4 to DUT 1 and DUT 2. Power divider 110_4 is positioned on the signal transmission path between port P4 and DUT 3, DUT 4 to distribute the measurement signal from port P4 to DUT 3 and DUT 4.

The signal receiving paths of the test platform 106 include multiple combining elements. In this embodiment, the combining elements are implemented as power combiners 112_1 through 112_4; however, the present disclosure is not limited thereto, and the combining elements may also be implemented using other suitable types of coupler elements.

The combining elements are configured to combine response signals generated by the devices under testing in response to the measurement signal and transmit the combined response signals to the measurement device 104. The response signals include reflected signals and transmitted signals generated by the devices under testing in response to the measurement signal. The reflected signals represent portions of the input measurement signal that are reflected at the input ports of the devices under testing, corresponding to scattering parameters S11 or S22. The transmitted signals represent portions of the input measurement signal that pass through from one port to another port of the devices under testing, corresponding to scattering parameters S21 or S12. The reflected signals and transmitted signals may be transmitted to different ports of the measurement device 104.

As shown in FIG. 1, when the measurement device 104 transmits a measurement signal via port P1, the measurement signal is transmitted to DUT 1 and DUT 2 through the signal transmission paths of the test platform 106. The reflected signals generated by DUT 1 and DUT 2 in response to the measurement signal are combined into a single signal by power combiner 112_1 positioned on the signal receiving path between port P1 and DUT 1, DUT 2, and transmitted back to port P1 of the measurement device 104. The reflected signals generated by DUT 3 and DUT 4 in response to the measurement signal are combined into a single signal by power combiner 112_2 positioned on the signal receiving path between port P2 and DUT 3, DUT 4, and transmitted back to port P2 of the measurement device 104.

Additionally, the transmitted signals generated by DUT 1 and DUT 2 in response to the measurement signal are combined into a single signal by power combiner 112_3 positioned on the signal receiving path between port P4 and DUT 1, DUT 2, and transmitted to port P4 of the measurement device 104. The transmitted signals generated by DUT 3 and DUT 4 in response to the measurement signal are combined into a single signal by power combiner 112_4 positioned on the signal receiving path between port P3 and DUT 3, DUT 4, and transmitted to port P3 of the measurement device 104.

One or more of the signal receiving paths each include a phase shifter. In this embodiment, phase shifters 1141 through 114_8 are respectively positioned on corresponding signal receiving paths. Each phase shifter may be switchable between a first phase value and a second phase value. The controller 102 is configured to individually control phase shifters 114_1 through 1148 to switch between the first phase value and the second phase value. In one embodiment, the first phase value and the second phase value may differ by 90 degrees; however, the present disclosure is not limited to this specific phase difference.

The controller 102 is configured to control the test platform 106 to switch between a first measurement stage and a second measurement stage. In the first measurement stage, a first group of phase shifters among phase shifters 114_1 through 114_8 (e.g., phase shifters 114_1 and 1145) may be set to the first phase value (e.g., 0 degrees), and a second group of the phase shifters (e.g., phase shifters 114_2 and 114_6) may be set to the second phase value (e.g., 90 degrees). In the second measurement stage, the first group of phase shifters may be set to the second phase value, and the second group of phase shifters may be set to the first phase value. This phase switching configuration enables the group testing system 100 to obtain sufficient measurement information to separate and individually identify response signals from each device under testing.

For a first device under testing and a second device under testing, included in the multiple devices under testing, that receive distributed signals from a common distribution element of the multiple distribution elements and respectively generate a first response signal and a second response signal in response to the distributed signals, at least one phase shifter of the multiple phase shifters imparts a phase shift to at least one of the first response signal and the second response signal before the first response signal and the second response signal are combined by one of the multiple combining elements, such that a predetermined phase difference exists between the first response signal and the second response signal. As shown in FIG. 1, DUT 1 and DUT 2 receive distributed signals from power divider 1101 (a common distribution element) and respectively generate a first response signal (reflected signal) and a second response signal (reflected signal). Before the first response signal and the second response signal are combined by power combiner 112_1, at least one of phase shifters 114_1 and 114_2 imparts a phase shift to at least one of the first response signal and the second response signal, such that a specific phase difference exists between the first response signal and the second response signal. In one embodiment, the specific phase difference may be 90 degrees to ensure orthogonality between the first response signal and the second response signal. For example, phase shifter 1141 may impart a 0-degree phase shift to the first response signal, and phase shifter 114_2 may impart a 90-degree phase shift to the second response signal, thereby establishing a 90-degree phase difference between the two signals.

The test platform 106 may further include at least one microwave element (e.g., directional couplers 116_1 through 116_12) and at least one circuit element (e.g., low noise amplifiers 118_1 through 118_8). For example, directional couplers 116_1 through 116_12 and low noise amplifiers 118_1 through 118_8 may be positioned on one or more of the signal transmission paths and one or more of the signal receiving paths of the test platform 106. These microwave elements and circuit elements are configured to compensate for signal path losses, provide signal isolation, and ensure that measurement signals and response signals travel along predetermined signal transmission paths and signal receiving paths, respectively.

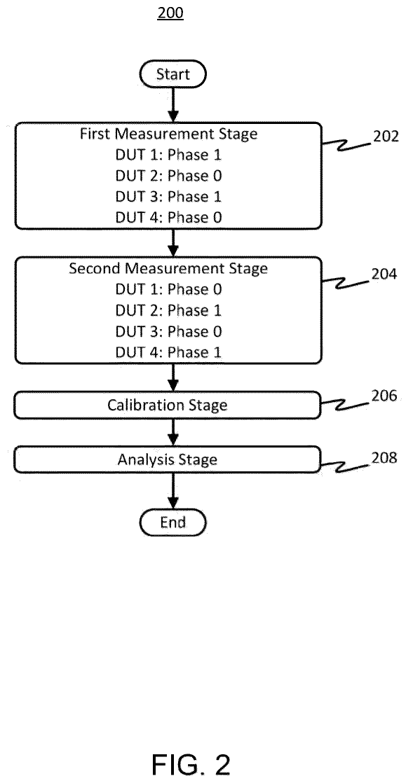

FIG. 2 is a flowchart of a group testing process 200 according to an embodiment of the present disclosure. The group testing process 200 includes a first measurement stage 202, a second measurement stage 204, a calibration stage 206, and an analysis stage 208. The group testing process 200 is described based on the group testing system 100 with DUT 1 through DUT 4 as examples, which may significantly reduce measurement time compared to traditional scattering parameter measurement processes. However, the present disclosure is not limited thereto. The number of devices under testing may be one or more, and the phase configurations of different devices under testing during different measurement stages may be adjusted based on measurement scenarios.

Referring to both FIG. 1 and FIG. 2, in the first measurement stage 202, the measurement device 104 (e.g., VNA) may transmit measurement signals to multiple devices under testing (e.g., DUT 1 through DUT 4) through multiple signal transmission paths, and receive response signals generated by the devices under testing in response to the measurement signals through multiple signal receiving paths, to obtain a set of parameter values corresponding to the devices under testing, including reflection parameters (e.g., S11, S22) and transmission parameters (e.g., S12, S21). Multiple phase shifters (such as phase shifters 114_1 through 1148) are positioned on the signal receiving paths. The signal receiving paths include reflected signal paths related to reflection parameter calculation and transmitted signal paths related to transmission parameter calculation. As previously described, the group testing system 100 may include one or more distribution elements (e.g., power dividers 110_1 through 110_4) and one or more combining elements (e.g., power combiners 112_1 through 112_4). The distribution elements are configured to distribute measurement signals from a single port of the measurement device 104 to the devices under testing. The combining elements are configured to combine response signals from the devices under testing and transmit them to the measurement device 104. In some embodiments, the distribution elements and combining elements may be implemented as 3 dB power dividers, respectively; however, the present disclosure is not limited thereto.

For two devices under testing receiving distributed signals from the same distribution element, the phase shifts of two phase shifters on their reflected signal paths may have a first specific difference. For example, the first specific difference may be 90 degrees to ensure orthogonality between signals on different reflected signal paths. Similarly, the phase shifts of two phase shifters on the transmitted signal paths of the two devices under testing may have a second specific difference. For example, the second specific difference may be 90 degrees to ensure orthogonality between signals on different transmitted signal paths.

As illustrated in FIG. 1, DUT 1 and DUT 2 both receive distributed signals from power divider 110_1. Therefore, phase shifter 114_1 positioned on the reflected signal path of DUT 1 and phase shifter 114_2 positioned on the reflected signal path of DUT 2 may be configured to have a first specific difference (e.g., 90 degrees). Similarly, phase shifter 114_5 positioned on the transmitted signal path of DUT 1 and phase shifter 114_6 positioned on the transmitted signal path of DUT 2 may be configured to have a second specific difference (e.g., 90 degrees).

In some embodiments, two phase shifters coupled to both ends of a device under testing may have the same phase shift amount, thereby simplifying subsequent scattering parameter calculations. For example, when DUT 1 operates in a first phase configuration (Phase 0), phase shifters 114_1 and 114_5 coupled to both ends of DUT 1 may both have the first phase value (e.g., 0 degrees); when operating in a second phase configuration (Phase 1), phase shifters 114_1 and 114_5 may both have the second phase value (e.g., 90 degrees).

Upon entering the second measurement stage 204, the phase shift of each phase shifter may switch to another phase value. Specifically, phase shifters originally set to the first phase value may switch to the second phase value, and phase shifters originally set to the second phase value may switch to the first phase value. For example, DUT 1 may operate in the first phase configuration during the first measurement stage 202, and switch to the second phase configuration upon entering the second measurement stage 204; while DUT 2 may operate in the second phase configuration during the first measurement stage 202, and switch to the first phase configuration upon entering the second measurement stage 204, and so on.

In the calibration stage 206 of the group testing process 200, the group testing system 100 may calculate corresponding error parameters (e.g., Error Terms) based on measurement signals transmitted by the measurement device 104 to the devices under testing and response signals received from the devices under testing. These error parameters are configured to correct for the effects of the measurement device 104 itself and various elements on the signal paths between the measurement device 104 and the devices under testing on the transmitted and reflected signals of the devices under testing. For example, a measurement signal transmitted from port P1 of the measurement device 104 may be divided into two paths via power divider 110_1 and transmitted to DUT 1 and DUT 2, respectively. The reflected signals from DUT 1 and DUT 2 may be coupled via directional couplers 1163, 116_4, then combined via power combiner 1121, merged with the original signal path through directional couplers 116_1, 116_2, and finally transmitted back to the measurement device 104 (via port P1). Similarly, the transmitted signals from DUT 1 and DUT 2 may be coupled via directional couplers 1169, 116_10, then combined via power combiner 1123, merged with the original signal path through directional couplers 1167, 1168, and finally transmitted to the measurement device 104 (via port P4). To accurately measure the reflected and transmitted signals of DUT 1 and DUT 2 while avoiding the effects of elements on the signal paths, external elements of the measurement device 104, such as directional couplers, power dividers, and power combiners may be equivalently treated as part of an error adapter. The group testing system 100 may execute a mixed signal path calibration procedure to calculate error parameters corresponding to the error adapter, thereby ensuring accurate calculation of scattering parameter values.

In the analysis stage 208 of the group testing process 200, the measurement device 104 may calculate scattering parameters of the devices under testing based on response signals received by the measurement device 104 during the first measurement stage 202 and the second measurement stage 204. In calculating these scattering parameters, the measurement device 104 may reference the error parameters obtained in the calibration stage 206 to compensate for the effects of elements on the signal paths on measurement results, thereby improving the accuracy of scattering parameter calculations. In some embodiments, the scattering parameters may be calculated by a computational processing device independent of the measurement device 104 based on the response signals, with reference to the error parameters during the calculation process.

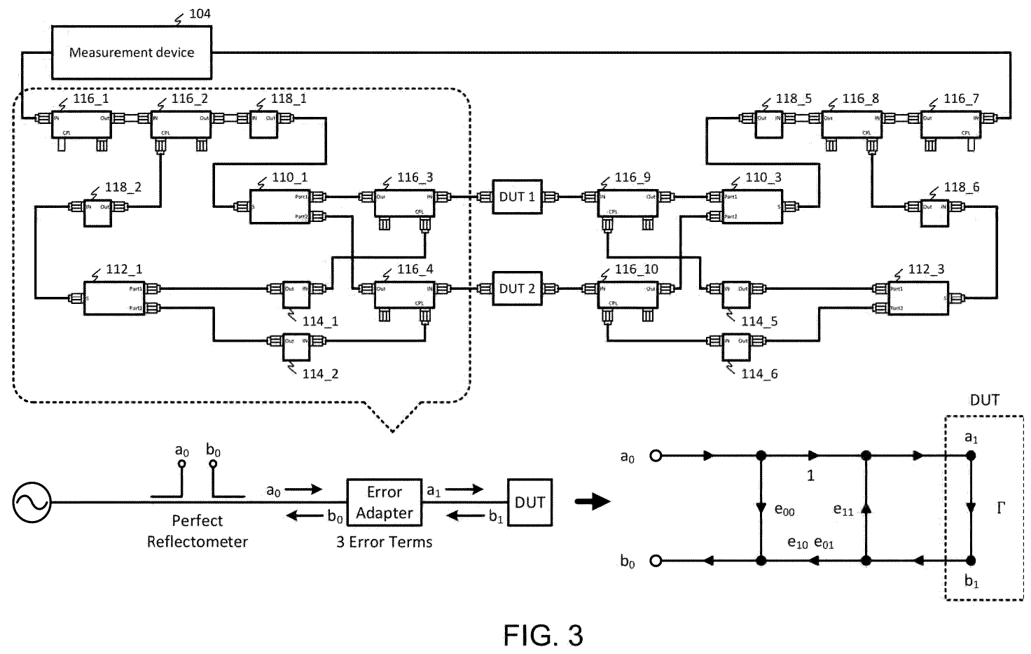

FIG. 3 is a schematic diagram of a mixed signal path calibration procedure according to an embodiment of the present disclosure. FIG. 3 shows the calibration process for DUT 1 and DUT 2, while the calibration process for DUT 3 and DUT 4 may be derived through similar procedures.

As described in the calibration stage 206 of FIG. 2, to accurately calculate scattering parameters of the devices under testing, external elements on the signal paths need to be equivalently treated as an error adapter. Specifically, one or more external elements on the signal transmission paths and signal receiving paths of DUT 1 and DUT 2, including but not limited to directional couplers 116_1 through 116_4, 116_7 through 116_10, power dividers 1101, 1103, power combiners 112_1, 1123, phase shifters 114_1, 114_2, 1145, 1146, and low noise amplifiers 118_1, 118_2, 118_5, 118_6, may be equivalently treated as an error adapter.

The group testing system 100 may determine error parameters corresponding to the error adapter according to the mixed signal path calibration procedure, enabling effective compensation for the effects of these external elements on measurement results when calculating scattering parameters in the analysis stage. As shown in the signal flow diagram in the lower half of FIG. 3, a₀ and b₀ represent signals transmitted from and returned to a perfect reflectometer, respectively, while a₁ and b₁ represent signals entering and leaving the device under testing (DUT), respectively. The measured reflection coefficient Γ_{M} may be defined as the ratio of b₀ to a₀, namely:

$${Γ}_{M} = \frac{{b}_{0}}{{a}_{0}} = \frac{{e}_{00} - {Δ}_{e} Γ}{1 - {e}_{11} Γ} \\ where {Γ}_{M} = \frac{{b}_{0}}{{a}_{0}} = \frac{{e}_{00} - {Δ}_{e} Γ}{1 - {e}_{11} Γ} .$$

The actual reflection coefficient F may be defined as:

$$Γ = \frac{{Γ}_{M} - {e}_{00}}{{Γ}_{M} {e}_{11} - {Δ}_{e}} .$$

The error adapter contains three error terms: directivity error (e₀₀), port match error (e₁₁), and tracking error (e₁₀·e₀₁). The measurement device 104 may execute a calibration procedure to determine these three error terms. For example, the measurement device 104 may measure reflection characteristics under three known standard states (e.g., open, short, and load) at the test ports of the test platform 106 where DUT 1 or DUT 2 would originally be connected, obtaining corresponding reflection coefficients Γ₁, Γ₂, and Γ₃. Additionally, the measured reflection coefficients Γ_{M1}, Γ_{M2}, and Γ_{M3} may correspond to the following linear equation:

$${e}_{00} + Γ {Γ}_{M} {e}_{11} - {ΓΔ}_{e} = {Γ}_{M} .$$

That is, the measured reflection coefficients Γ_{M1}, Γ_{M2}, and Γ_{M3} may correspond to the following equations respectively:

$${e}_{00} + {Γ}_{1} {Γ}_{M} {e}_{11} - {Γ}_{1} {Δ}_{e} = {Γ}_{M 1} , \\ {e}_{00} + {Γ}_{2} {Γ}_{M} {e}_{11} - {Γ}_{2} {Δ}_{e} = {Γ}_{M 2} , and \\ {e}_{00} + {Γ}_{3} {Γ}_{M} {e}_{11} - {Γ}_{3} {Δ}_{e} = {Γ}_{M 3} .$$

Solving these three simultaneous equations yields e₀₀, e₁₁, and Δₑ, thereby obtaining the three desired error terms. Through the mixed signal path calibration procedure, error parameters (e.g., error terms) representing the overall effect of external elements of the measurement device 104 may be effectively estimated. These error parameters may be used in subsequent analysis stages to compensate for the effects of external elements of the measurement device 104 on measurement results, thereby calculating accurate scattering parameters.

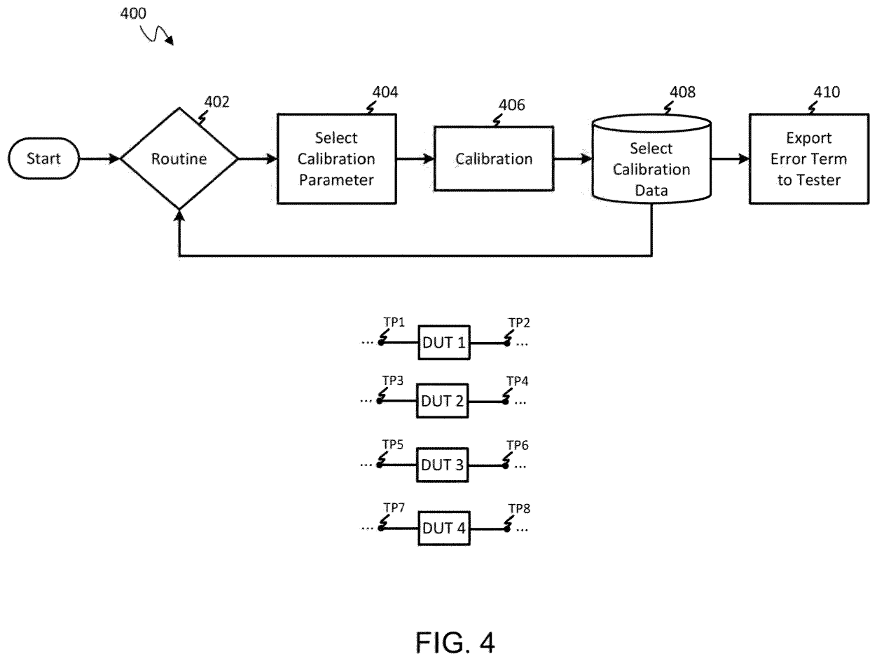

FIG. 4 is a flowchart of a calibration process 400 according to an embodiment of the present disclosure. The calibration process 400 shows steps of executing calibration procedures for test ports TP1 through TP8, where both ends of DUT 1 are test ports TP1 and TP2, both ends of DUT 2 are test ports TP3 and TP4, both ends of DUT 3 are test ports TP5 and TP6, and both ends of DUT 4 are test ports TP7 and TP8. Although the calibration process is described with DUT 1 through DUT 4 as examples, the present disclosure is not limited thereto. The number of test ports and corresponding devices under testing may be adjusted according to actual measurement requirements. The calibration process 400 includes steps 402, 404, 406, 408, and 410.

In step 402, the measurement device 104 may execute routine procedures to calibrate each test port sequentially. Taking the calibration of test port TP1 as an example, the measurement device 104 may sequentially select calibration standards, such as open, short, load, and thru for measurement, and calculate error parameters under the corresponding states. During calibration of test port TP1, the remaining test ports (e.g., test ports TP2 through TP8) may all be connected to loads to prevent reflected signals from these test ports from affecting calibration accuracy. After completing calibration of test port TP1, the measurement device 104 may execute the same calibration procedure for test port TP2, with test port TP1 and test ports TP3 through TP8 all connected to loads at this time. Similarly, the measurement device 104 may calibrate test ports TP3 through TP8 one by one until completing calibration procedures for all eight test ports.

The execution order of the calibration process 400 is flexible and may be adjusted according to measurement environment or specific settings. For example, the measurement device 104 may first complete calibration of test ports TP1, TP3, TP5, TP7 (i.e., the first end of each device under testing) for all devices under testing, then proceed with calibration of test ports TP2, TP4, TP6, TP8 (i.e., the second end of each device under testing); or adjust the calibration order based on other optimization considerations.

In step 404, the measurement device 104 may select appropriate calibration parameter combinations based on the currently calibrated test port and required calibration accuracy. In step 406, the measurement device 104 may execute actual measurement and error parameter calculation. In step 408, the measurement device 104 may organize and store the calculated error parameters as calibration data.

After completing calibration of all test ports, in step 410, the measurement device 104 may output the calibration data to a tester. The calibration data may be transmitted to an external computing device (e.g., tester) for subsequent scattering parameter calculation. Alternatively, the measurement device 104 may integrate tester functions and directly utilize the calibration data and response signals received during the first and second measurement stages to calculate scattering parameters of each device under testing.

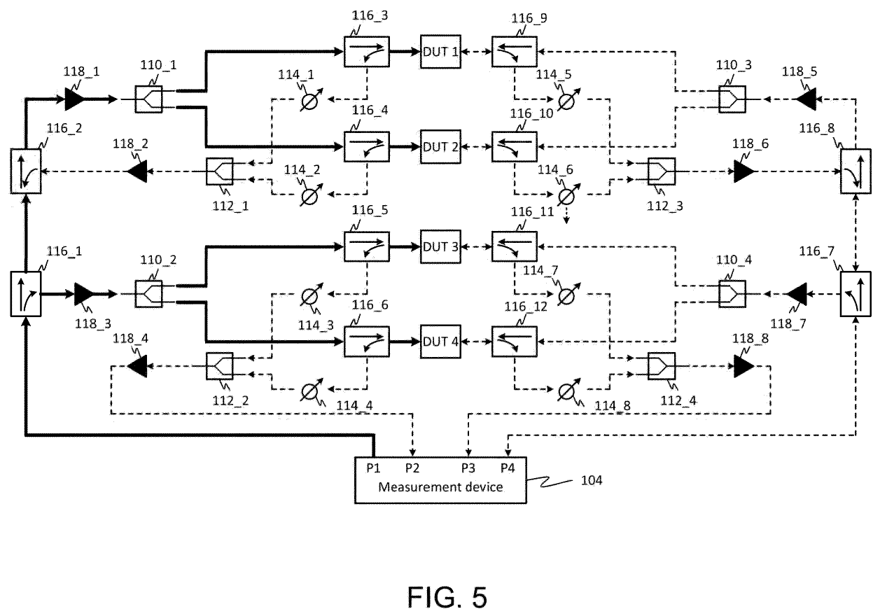

FIG. 5 shows signal transmission paths from port P1 of the measurement device 104 to each device under testing according to an embodiment of the present disclosure. FIG. 5 shows with solid lines the main signal paths for transmitting measurement signals from port P1 to DUT 1 through DUT 4, and shows other signal paths with dashed lines.

When port P1 of the measurement device 104 transmits a continuous wave (CW) measurement signal, the measurement signal may pass through directional coupler 116_1, then on one hand be transmitted to DUT 1 and DUT 2 via low noise amplifier 1181, and on the other hand be transmitted to DUT 3 and DUT 4 via low noise amplifier 118_3. Directional coupler 116_1 may receive the measurement signal from port P1 and transmit signals to directional coupler 116_2 and low noise amplifier 118_3 through its output port and coupling port, respectively. Directional coupler 116_2 may receive the output signal from directional coupler 116_1 and transmit signals to low noise amplifier 118_1 and low noise amplifier 118_2 through its output port and coupling port, respectively. However, due to the directionality of low noise amplifiers, low noise amplifier 118_2 may block signals from the coupling port of directional coupler 116_2.

Low noise amplifier 118_1 is configured to compensate for signal path losses through directional coupler 116_1, directional coupler 116_2, power divider 110_1, directional coupler 116_3, and directional coupler 1164 to DUT 1 and DUT 2, and to block signals reflected by power divider 110_1, directional coupler 1163, directional coupler 116_4, DUT 1, and DUT 2.

Similarly, low noise amplifier 118_3 is configured to compensate for signal path losses through directional coupler 1161, power divider 110_2, directional coupler 1165, and directional coupler 116_6 to DUT 3 and DUT 4, and to block signals reflected by power divider 1102, directional coupler 1165, directional coupler 1166, DUT 3, and DUT 4.

Power divider 110_1 and power divider 110_2 may respectively receive output signals from low noise amplifier 118_1 and low noise amplifier 118_3. Power divider 110_1 may divide the received signal into two paths and transmit them to directional couplers 116_3 and 116_4, respectively. Power divider 110_2 may divide the received signal into two paths and transmit them to directional couplers 116_5 and 1166, respectively. These directional couplers may transmit measurement signals to corresponding devices under testing. Through this signal transmission path configuration, port P1 of the measurement device 104 may simultaneously provide measurement signals to all devices under testing (such as DUT 1 through DUT 4).

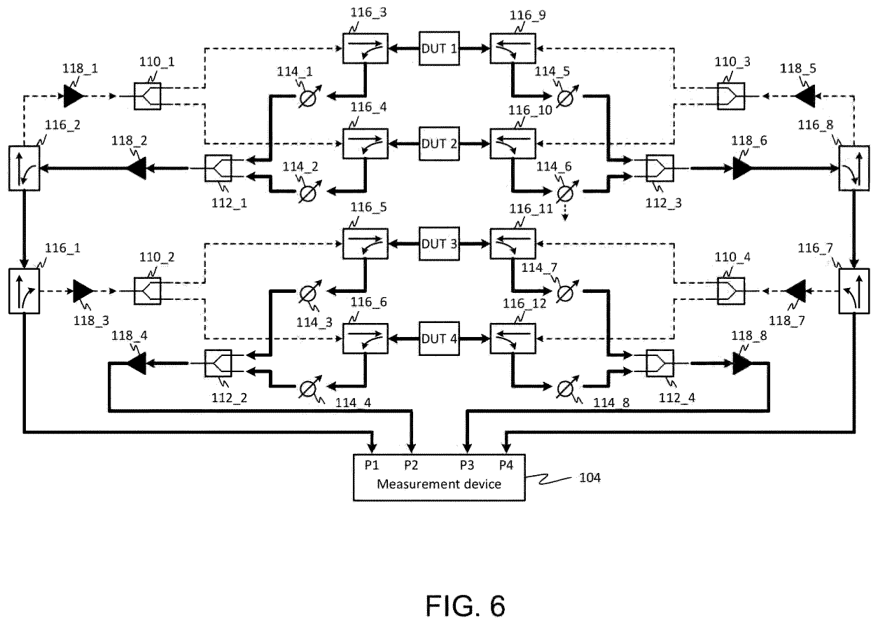

FIG. 6 shows signal receiving paths from each device under testing to the measurement device 104 according to an embodiment of the present disclosure. FIG. 6 shows with solid lines the main signal paths for reflected and transmitted signals generated by DUT 1 through DUT 4 returning to various ports of the measurement device 104, and shows other signal paths with dashed lines. The signal receiving paths shown in FIG. 6 correspond to return paths for reflected and transmitted signals generated by each device under testing after port P1 of the measurement device 104 transmits measurement signals in FIG. 5.

As shown in FIG. 6, reflected signals from DUT 1 and DUT 2 may return to port P1 of the measurement device 104 via directional coupler 1163, directional coupler 116_4, phase shifter 114_1, phase shifter 114_2, power combiner 112_1, low noise amplifier 118_2, directional coupler 116_2, and directional coupler 116_1.

The reflected signal from DUT 1 and the reflected signal from DUT 2 may be transmitted to two input ports of power combiner 112_1 via phase shifter 114_1 and phase shifter 114_2, respectively. The phase shifts of phase shifter 1141 and phase shifter 114_2 may be set to differ by 90 degrees, such that orthogonality exists between the two received signals at power combiner 112_1. For example, in the first measurement stage, the phase shifts of phase shifter 114_1 and phase shifter 114_2 may be 0 degrees and 90 degrees, respectively. Upon switching from the first measurement stage to the second measurement stage, the phase shifts of phase shifter 114_1 and phase shifter 114_2 may switch to 90 degrees and 0 degrees, respectively.

Power combiner 112_1 may combine the two received signals and output the combined signal to low noise amplifier 118_2. Low noise amplifier 118_2 is configured to compensate for reflected signal path losses of DUT 1 and DUT 2 through directional coupler 1163, directional coupler 116_4, phase shifter 114_1, phase shifter 114_2, power combiner 112_1, directional coupler 116_2, and directional coupler 1161, and to block signals coupled by directional coupler 116_2. After the measurement device 104 receives the mixed reflected signals from DUT 1 and DUT 2 at port P1, separation and calculation using algorithms may yield the reflection parameters (e.g., S11 parameters) of DUT 1 and DUT 2.

Similarly, reflected signals from DUT 3 and DUT 4 may return to port P2 of the measurement device 104 via directional coupler 1165, directional coupler 1166, phase shifter 114_3, phase shifter 114_4, power combiner 112_2, and low noise amplifier 118_4. The reflected signal from DUT 3 and the reflected signal from DUT 4 may be transmitted to two input ports of power combiner 112_2 via phase shifter 114_3 and phase shifter 114_4, respectively. The phase shifts of phase shifter 114_3 and phase shifter 114_4 may be set to differ by 90 degrees, such that orthogonality exists between the two received signals at power combiner 112_2. For example, in the first measurement stage, the phase shifts of phase shifter 114_3 and phase shifter 114_4 may be 0 degrees and 90 degrees, respectively. Upon switching from the first measurement stage to the second measurement stage, the phase shifts of phase shifter 114_3 and phase shifter 1144 may switch to 90 degrees and 0 degrees, respectively.

Power combiner 112_2 may combine the two received signals and output the combined signal to low noise amplifier 118_4. Low noise amplifier 118_4 is configured to compensate for reflected signal path losses of DUT 3 and DUT 4 through directional coupler 1165, directional coupler 1166, phase shifter 1143, phase shifter 114_4, and power combiner 112_2. After the measurement device 104 receives the mixed reflected signals from DUT 3 and DUT 4 at port P2, separation and calculation using algorithms may yield the S11 parameters of DUT 3 and DUT 4.

On the other hand, transmitted signals from DUT 1 and DUT 2 may return to port P4 of the measurement device 104 via directional coupler 1169, directional coupler 116_10, phase shifter 1145, phase shifter 1146, power combiner 1123, low noise amplifier 1186, directional coupler 116_8, and directional coupler 116_7. Power combiner 112_3 may operate similarly to the aforementioned power combiners, receiving transmitted signals from DUT 1 and DUT 2 via phase shifters 114_5 and 1146, respectively, to ensure orthogonality between the two received signals.

Low noise amplifier 118_6 is configured to compensate for transmitted signal path losses of DUT 1 and DUT 2 through directional coupler 1169, directional coupler 116_10, phase shifter 1145, phase shifter 1146, power combiner 1123, directional coupler 1168, and directional coupler 1167, and to block signals coupled by directional coupler 116_8. After the measurement device 104 receives the mixed transmitted signals from DUT 1 and DUT 2 at port P4, separation and calculation using algorithms may yield the transmission parameters (e.g., S21 parameters) of DUT 1 and DUT 2.

Transmitted signals from DUT 3 and DUT 4 may return to port P3 of the measurement device 104 via directional coupler 116_11, directional coupler 116_12, phase shifter 1147, phase shifter 1148, power combiner 112_4, and low noise amplifier 118_8. Power combiner 112_4 may receive transmitted signals from DUT 3 and DUT 4 via phase shifters 114_7 and 1148, respectively, to ensure orthogonality between the two received signals. Low noise amplifier 118_8 is configured to compensate for transmitted signal path losses of DUT 3 and DUT 4 through directional coupler 116_11, directional coupler 116_12, phase shifter 1147, phase shifter 1148, and power combiner 112_4. After the measurement device 104 receives the mixed transmitted signals from DUT 3 and DUT 4 at port P3, separation and calculation using algorithms may yield the transmission parameters (e.g., S21 parameters) of DUT 3 and DUT 4.

Through the signal receiving path configuration shown in FIG. 6, combined with the orthogonality provided by phase shifters and path loss compensation by low noise amplifiers, the group testing system 100 may effectively receive and separate response signals from multiple devices under testing, achieving the goal of simultaneously measuring scattering parameters of multiple devices under testing.

To measure parameters, such as S22 and S12 of DUT 1 through DUT 4, the group testing system 100 may alternatively transmit measurement signals from port P4 of the measurement device 104. The measurement signal may be transmitted to DUT 1 through DUT 4 via the right half path of the system, including directional coupler 116_7, directional coupler 1168, and corresponding low noise amplifiers, power dividers, and other elements. Reflected signals generated by each device under testing, in response to the measurement signal from port P4, may return to ports P3 and P4 for calculating S22 parameters, while transmitted signals may return to ports P1 and P2 for calculating S12 parameters. This operating mechanism has a symmetric configuration with the aforementioned architecture of transmitting measurement signals from port P1 through the left half path of the system to DUT 1 through DUT 4, and the operating principles of related elements are substantially the same. This symmetric architecture design enables the group testing system 100 to completely measure all four scattering parameters (S11, S12, S21, S22) of each device under testing, achieving comprehensive scattering parameter measurement.

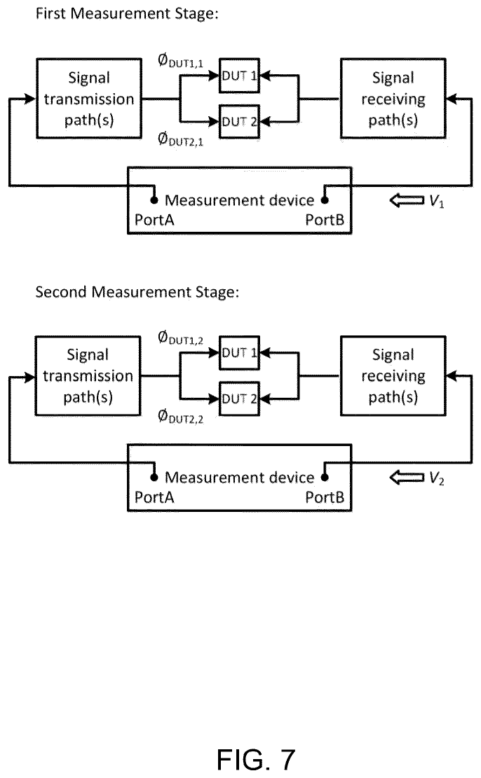

FIG. 7 is a schematic diagram illustrating calculation of scattering parameters of devices under testing by the measurement device based on measurement results from the first measurement stage and second measurement stage according to an embodiment of the present disclosure. FIG. 7 uses DUT 1 and DUT 2 as examples to illustrate how to separate and calculate scattering parameters of two devices under testing receiving distributed signals from a common distribution element. Based on the same mechanism, scattering parameters of other devices under testing coupled to the same distribution element (such as DUT 3 and DUT 4 in FIG. 1) may also be calculated.

As shown in FIG. 7, in the first measurement stage, port A of the measurement device (e.g., measurement device 104 in FIG. 1) may transmit measurement signals to DUT 1 and DUT 2 via signal transmission paths. The signal arriving at DUT 1 via the signal transmission path is φ_{DUT1,1}, and the signal arriving at DUT 2 is φ_{DUT2,1}. DUT 1 and DUT 2 generate response signals in response to these signals, respectively, and these response signals return to port B of the measurement device via signal receiving paths, where port A and port B may be the same or different ports, depending on the type of scattering parameters to be measured and corresponding signal transmission/reception paths. The measurement device may obtain a first measurement result V₁ corresponding to the first measurement stage as follows:

$${V}_{1} = [ \begin{matrix}{e}^{j {ϕ}_{DUT 1 , 1}} & {e}^{j {ϕ}_{DUT 2 , 1}} ] [ \begin{matrix}{a}_{1} \\ {a}_{2}\end{matrix} ]\end{matrix} = {a}_{1} {e}^{j {ϕ}_{DUT 1 , 1}} + {a}_{2} {e}^{j {ϕ}_{DUT 2 , 1}} ,$$

where a₁ and a₂ are scattering parameter values of DUT 1 and DUT 2, respectively.

In the second measurement stage, phase shifters may switch to different phase configurations. Since phase shifters switch phases between the first measurement stage and second measurement stage with a specific phase difference (e.g., 90 degrees), signals arriving at DUT 1 and DUT 2 via signal transmission paths become φ_{DUT1,2} and φ_{DUT2,2}, respectively. Response signals generated by DUT 1 and DUT 2 in response to these signals during the second measurement stage return to port B via signal receiving paths. Therefore, the measurement device may obtain a second measurement result V₂ corresponding to the second measurement stage as follows:

$${V}_{2} = [ \begin{matrix}{e}^{j {ϕ}_{DUT 1 , 2}} & {e}^{j {ϕ}_{DUT 2 , 2}} ] [ \begin{matrix}{a}_{1} \\ {a}_{2}\end{matrix} ]\end{matrix} = {a}_{1} {e}^{j {ϕ}_{DUT 1 , 2}} + {a}_{2} {e}^{j {ϕ}_{DUT 2 , 2}} .$$

Based on measurement results (V₁, V₂) from the first and second measurement stages, a matrix equation may be established as follows:

$$V = [ \begin{matrix}{μ}_{11} & {μ}_{12} \\ {μ}_{21} & {μ}_{22}\end{matrix} ] [ \begin{matrix}{a}_{1} \\ {a}_{2}\end{matrix} ] = {V}_{1} + {V}_{2} ,$$

where V represents the sum of signals received by the measurement device during different measurement stages, and μ₁₁, μ₁₂, μ₂₁, μ₂₂ represent phase values imparted by signal receiving paths of the test platform when a device under testing is in the first or second measurement stage.

Since phase configurations of phase shifters differ between the two measurement stages, a₁ and a₂ may be solved as follows:

$$[ \begin{matrix}{a}_{1} \\ {a}_{2}\end{matrix} ] = {[ \begin{matrix}{μ}_{11} & {μ}_{12} \\ {μ}_{21} & {μ}_{22}\end{matrix} ]}^{- 1} [ \begin{matrix}{V}_{1} \\ {V}_{2}\end{matrix} ] .$$

Based on multiple measurement results [V₁ . . . Vₙ] and the inverse matrix of state phase shifts [μ₁₁, μ₁₂, μ₂₁, μ₂₂], multiplication of the two yields actual transmitted or reflected signals (such as a₁, a₂) of each DUT. In other words, a₁ and a₂ in the above formula may represent scattering parameter values SXY_{DUT(N)} of corresponding DUTs, depending on the port configuration used by the measurement device for transmitting and receiving during measurement. For example, assuming both port A for transmitting measurement signals and port B for receiving signals are port P1 as shown in FIG. 1, then based on the configuration of group testing system 100, a₁ and a₂ may respectively represent S11 parameters of DUT1 and DUT2, namely S11_{DUT(1)} and S11_{DUT(2)}.

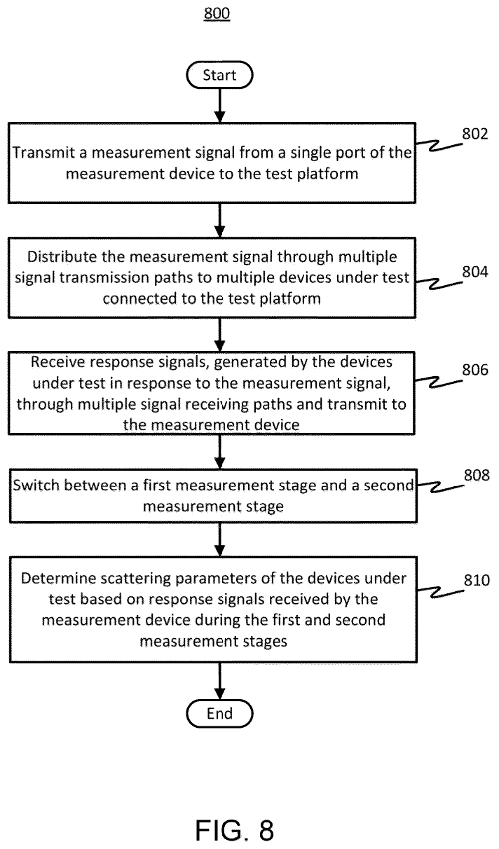

FIG. 8 is a flowchart of a group testing method according to an embodiment of the present disclosure. Process 800 uses a measurement device and a test platform to simultaneously measure scattering parameters of multiple devices under testing. Process 800 includes steps 802, 804, 806, 808, and 810.

In step 802, a measurement signal may be transmitted from a single port of the measurement device to the test platform. For example, in the embodiment shown in FIG. 1, measurement device 104 may transmit a measurement signal to test platform 106 via port P1.

In step 804, the measurement signal may be distributed through multiple signal transmission paths including multiple distribution elements to multiple devices under testing connected to the test platform. The distribution elements (e.g., power dividers 110_1 through 1104 in FIG. 1) may distribute the measurement signal from a single port to multiple devices under testing, enabling a single measurement signal to be simultaneously transmitted to all devices under testing.

In step 806, response signals generated by the devices under testing in response to the measurement signal may be received through multiple signal receiving paths including multiple combining elements and transmitted to the measurement device. One or more of the signal receiving paths each include a phase shifter. For a first device under testing and a second device under testing receiving distributed signals from a common distribution element, before the first response signal and second response signal respectively generated are combined by a combining element, at least one phase shifter may impart a phase shift to at least one of the first response signal and the second response signal, such that a specific phase difference exists between the first response signal and the second response signal. The specific phase difference (e.g., 90 degrees) ensures orthogonality between response signals from different devices under testing, enabling subsequent separation of individual responses from each device under testing. The combined response signals may be transmitted to corresponding ports of the measurement device.

In step 808, the test platform may be controlled to switch between a first measurement stage and a second measurement stage. In the first measurement stage, phase shifters may be set to a first phase configuration; in the second measurement stage, phase shifters may switch to a second phase configuration. Specifically, phase shifters originally set to the first phase value may switch to the second phase value, and phase shifters originally set to the second phase value may switch to the first phase value. Through this phase switching, the system may obtain measurement results with different phase characteristics during different measurement stages.

In step 810, scattering parameters of the devices under testing may be determined based on response signals received by the measurement device during the first and second measurement stages. As shown in FIG. 7, by establishing and solving matrix equations, individual scattering parameter values of each device under testing may be separated from mixed measurement signals. Different measurement results obtained during the first and second measurement stages provide sufficient information to solve for scattering parameters of each device under testing. This group testing method enables a single measurement device to simultaneously measure multiple devices under testing, significantly improving test efficiency and reducing test costs.

According to the group testing system and the group testing method described in embodiments of the present disclosure, the measurement device may simultaneously transmit measurement signals to all devices under testing through a single port, and reflected and transmitted signals generated by each device under testing in response to the measurement signal may be transmitted to multiple ports of the measurement device via multiple signal receiving paths. Phase shifters may be positioned on one or more of the signal receiving paths. For devices under testing receiving distributed signals from a common distribution element, before response signals generated are combined by combining elements, phase shifters may impart specific phase differences to make these response signals distinguishable, facilitating subsequent algorithmic separation of individual responses from each device under testing. The specific phase difference may be adjusted according to system design and algorithm requirements.

It should be noted that although the group testing system 100 in embodiments of the present disclosure includes only four devices under testing, the present disclosure is not limited thereto. The group testing system described in embodiments of the present disclosure may support any number of devices under testing. The measurement device may transmit measurement signals to multiple devices under testing (e.g., all devices under testing) at once, and through the above approach, the phase shifters on different signal receiving paths may impart appropriate phase shifts to the signals, thereby enabling the measurement device to analyze corresponding measurement parameters (e.g., reflection parameters, scattering parameters, etc.) from received measurement results. In some embodiments, multiple devices under testing may be appropriately grouped (e.g., if there are eight devices under testing in total, every four devices under testing may be grouped together), each group of devices under testing and the measurement device may have a circuit configuration like group testing system 100, and the measurement device may switchably operate between different groups of devices under testing.

Additionally, although the measurement device in group testing system 100 has four ports (P1 through P4), the present disclosure is not limited thereto. In some embodiments, the measurement device may have more or fewer than four ports. For example, the group testing system 100 may introduce one or more switches (or other switching elements) to route received signals to specific ports of the measurement device during different operating stages, thereby reducing the number of ports required for the measurement device.

The group testing system and method provided by the present disclosure may enable simultaneous measurement of scattering parameters of multiple devices under testing with a single measurement device, effectively separating individual responses from each device under testing through phase differences provided by phase shifters and application of corresponding algorithms, significantly improving test efficiency and reducing test costs. Furthermore, the system architecture has high scalability and flexibility, allowing adjustment of the number of devices under testing, port configuration, and element parameters according to actual needs, making it suitable for various measurement application scenarios.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A test platform adapted to connect to a measurement device and a plurality of devices under testing, the test platform comprising:
a plurality of signal transmission paths including a plurality of distribution elements configured to distribute a measurement signal from a single port of the measurement device to the plurality of devices under testing; and
a plurality of signal receiving paths including a plurality of combining elements and a plurality of phase shifters, wherein:
each combining element of the plurality of combining elements is configured to combine response signals from at least two of the plurality of devices under testing and output a combined signal to the measurement device, and
for a first device under testing and a second device under testing, included in the plurality of devices under testing, that receive distributed signals from a common distribution element of the plurality of distribution elements and respectively generate a first response signal and a second response signal in response to the distributed signals, at least one phase shifter of the plurality of phase shifters imparts a phase shift to at least one of the first response signal and the second response signal before the first response signal and the second response signal are combined by one of the plurality of combining elements, such that a predetermined phase difference exists between the first response signal and the second response signal.

2. The test platform of claim 1, wherein the predetermined phase difference is 90 degrees.

3. The test platform of claim 1, wherein each phase shifter of the plurality of phase shifters is switchable between a first phase value and a second phase value.

4. The test platform of claim 3, wherein the first phase value and the second phase value differ by 90 degrees.

5. The test platform of claim 1, wherein:
the response signals include reflected signals and transmitted signals, and
the plurality of signal receiving paths is configured to route the reflected signals and the transmitted signals to different ports of the measurement device.

6. The test platform of claim 1, further comprising a plurality of low noise amplifiers positioned along one or more of the plurality of signal transmission paths and one or more of the plurality of signal receiving paths.

7. The test platform of claim 1, wherein the plurality of distribution elements comprises power dividers.

8. The test platform of claim 1, wherein the plurality of combining elements comprises power combiners.

9. A group testing system comprising:
a measurement device;
a test platform electrically connected to the measurement device and configured for connection to a plurality of devices under testing, the test platform comprising:
a plurality of signal transmission paths including a plurality of distribution elements configured to distribute a measurement signal from a single port of the measurement device to the plurality of devices under testing; and
a plurality of signal receiving paths including a plurality of combining elements and a plurality of phase shifters, wherein:
each combining element of the plurality of combining elements is configured to combine response signals from at least two of the plurality of devices under testing and output a combined signal to the measurement device, and
for a first device under testing and a second device under testing, included in the plurality of devices under testing, that receive distributed signals from a common distribution element of the plurality of distribution elements and respectively generate a first response signal and a second response signal in response to the distributed signals, at least one phase shifter of the plurality of phase shifters imparts a phase shift to at least one of the first response signal and the second response signal before the first response signal and the second response signal are combined by one of the plurality of combining elements, such that a predetermined phase difference exists between the first response signal and the second response signal; and
a controller coupled to the measurement device and the test platform, the controller configured to switch the test platform between a first measurement stage and a second measurement stage by controlling phase values of the plurality of phase shifters,
wherein the measurement device is configured to determine scattering parameters of the plurality of devices under testing based on signals received during the first measurement stage and the second measurement stage.

10. The group testing system of claim 9, wherein the predetermined phase difference is 90 degrees.

11. The group testing system of claim 9, wherein:
each phase shifter of the plurality of phase shifters is switchable between a first phase value and a second phase value,
during the first measurement stage, the controller sets a first group of the plurality of phase shifters to the first phase value and a second group of the plurality of phase shifters to the second phase value, and
during the second measurement stage, the controller sets the first group of the plurality of phase shifters to the second phase value and the second group of the plurality of phase shifters to the first phase value.

12. The group testing system of claim 11, wherein the first phase value and the second phase value differ by 90 degrees.

13. The group testing system of claim 9, wherein:
the response signals include reflected signals and transmitted signals, and
the plurality of signal receiving paths is configured to route the reflected signals and the transmitted signals to different ports of the measurement device.

14. The group testing system of claim 9, further comprising a plurality of low noise amplifiers positioned along one or more of the plurality of signal transmission paths and one or more of the plurality of signal receiving paths.

15. The group testing system of claim 9, wherein the plurality of distribution elements comprises power dividers.

16. The group testing system of claim 9, wherein the plurality of combining elements comprises power combiners.

17. A method for group testing of devices under testing, the method comprising:
transmitting a measurement signal from a single port of a measurement device through a test platform;
distributing the measurement signal through a plurality of signal transmission paths to a plurality of devices under testing that is connected to the test platform, the plurality of signal transmission paths including a plurality of distribution elements;
receiving response signals, generated by the plurality of devices under testing in response to the measurement signal, through a plurality of signal receiving paths and transmitting the response signals to the measurement device, the plurality of signal receiving paths including a plurality of combining elements and a plurality of phase shifters, wherein:
for a first device under testing and a second device under testing, included in the plurality of devices under testing, that receive distributed signals from a common distribution element of the plurality of distribution elements and respectively generate a first response signal and a second response signal in response to the distributed signals, at least one phase shifter of the plurality of phase shifters imparts a phase shift to at least one of the first response signal and the second response signal before the first response signal and the second response signal are combined by one of the plurality of combining elements, such that a predetermined phase difference exists between the first response signal and the second response signal;
controlling the test platform to switch between a first measurement stage and a second measurement stage; and
determining scattering parameters of the plurality of devices under testing based on the response signals received by the measurement device during the first measurement stage and the second measurement stage.

18. The method of claim 17, wherein the predetermined phase difference is 90 degrees.

19. The method of claim 17, wherein switching between the first measurement stage and the second measurement stage comprises:
during the first measurement stage, setting a first group of the plurality of phase shifters to a first phase value and a second group of the plurality of phase shifters to a second phase value; and
during the second measurement stage, setting the first group of the plurality of phase shifters to the second phase value and the second group of the plurality of phase shifters to the first phase value.

20. The method of claim 19, wherein the first phase value and the second phase value differ by 90 degrees.
